(19) United States
(12) Patent Application Publication
(10) Pub. No.: US 2009/0154121 A1
(43) Pub. Date: Jun. 18, 2009

(54) Clock generator

(75) Inventor: Chih-Chien Lee, Taipei City (TW)

Correspondence Address: Joe McKinney Muncy, PO Box 1364, Fairfax, VA, 22038-1364, US

(73) Assignee: Inventec Corporation

(21) Appl. No.: 12/000,861

(22) Filed: Dec. 18, 2007

(51) Int. Cl. H02B 1/00

(52) U.S. Cl. 361/761

(57) ABSTRACT

A clock generator includes a printed circuit board, a resonant circuit and a pair of compensating capacitors. The resonant circuit is disposed on the printed circuit board. The compensating capacitors are embedded in the printed circuit board and electrically connected to both terminals of the resonant circuit respectively.

### BACKGROUND

1. Field of Invention

The present invention relates to an active device. More particularly, the present invention relates to a clock generator.

2. Description of Related Art

A clock generator is a circuit that produces a set and stable timing signal (known as a clock signal and behaves as such). Many integrated circuits (ICs) need the clock generator to provide a specific timing signal as a basis for data transmission between ICs, thereby synchronizing their operations.

For example, conventional personal computers or servers always need a clock generator configured on the motherboard thereof to generate a main timing signal. The reason for configuring the clock generator is that many devices, such as universal serial bus (USB), peripheral component interconnect (PCI), dual inline memory module (DIMM) and central processing unit (CPU), on the motherboard need the main timing signal to synchronize their operations. Accordingly, the accuracy of the main timing signal generated by the clock generator relate to whether the personal computers or servers operate correctly or not.

### SUMMARY

According to one embodiment of the present invention, a clock generator includes a printed circuit board, a resonant circuit and a pair of compensating capacitors. The resonant circuit is disposed on the printed circuit board. The compensating capacitors are embedded in the printed circuit board and electrically connected to both terminals of the resonant circuit respectively.

According to another embodiment of the present invention, a clock generator includes a printed circuit board, a pair of first electrodes, a pair of second electrodes, a resonant circuit, a pair of first conductive lines and a pair of second conductive lines. The printed circuit board includes a first dielectric layer, a second dielectric layer and a third dielectric layer. The second dielectric layer is stacked on the first dielectric layer. The third dielectric layer is stacked on the second dielectric layer. The first electrodes are located between the first dielectric layer and the second dielectric layer and separated from each other. The second electrodes are located between the second dielectric layer and the third dielectric layer and separated from each other. The projections of the second electrodes on the first dielectric layer overlap the first electrodes respectively. The resonant circuit is disposed on the printed circuit board. The first conductive lines electrically connect both terminals of the resonant circuit to the second electrodes respectively. The second conductive lines electrically connect the first electrodes to an outside potential.

### BRIEF DESCRIPTION OF THE DRAWINGS

The invention can be more fully understood by reading the following detailed description of the embodiment, with reference made to the accompanying drawings as follows:

FIG. 1 is a longitudinal sectional view of a clock generator according to one embodiment of the present invention.

### DETAILED DESCRIPTION

Reference will now be made in detail to the present embodiments of the invention, examples of which are illustrated in the accompanying drawings.

Wherever possible, the same reference numbers are used in the drawings and the description to refer to the same or like parts.

Basically, a clock generator includes a crystal oscillator to generate a timing signal. In order to make the timing signal set and stable, a pair of compensating capacitors are often electrically connected to both terminals of the crystal oscillator. However, if the compensating capacitors are configured on the surface of the printed circuit board of the clock generator, the compensating capacitors will not only occupy a lot of the surface of the printed circuit board but also lose the competence of the clock generator due to additional costs of procurement, stock and assembly. Therefore, the following embodiments of the present invention will provide a clock generator, whose compensating capacitors are embedded in the printed circuit board, thereby solving the above mentioned problems.

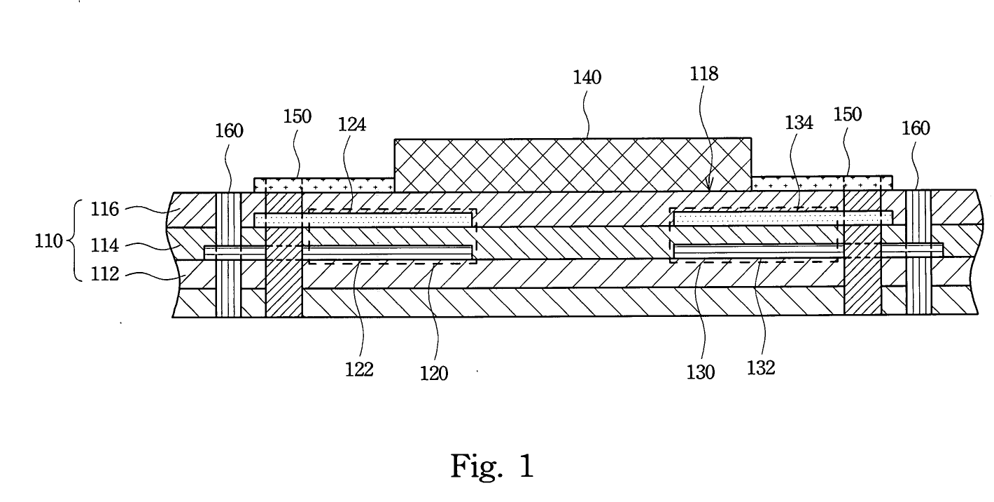

FIG. 1 is a longitudinal sectional view of a clock generator according to one embodiment of the present invention. The clock generator includes a printed circuit board 110, a resonant circuit 140 and a pair of compensating capacitors 120/130. The resonant circuit 140 is disposed on the printed circuit board 110. The compensating capacitors 120/130 are embedded in the printed circuit board 110 and electrically connected to both terminals of the resonant circuit 140 respectively.

Specifically, the printed circuit board 110 shown in FIG. 1 is a multi-layer circuit board. That is, the printed circuit board 110 includes a first dielectric layer 112, a second dielectric layer 114 and a third dielectric layer 116. The second dielectric layer 114 is stacked on the first dielectric layer 112. The third dielectric layer 116 is stacked on the second dielectric layer 114. Furthermore, the printed circuit board 110 (including the first dielectric layer 112, the second dielectric layer 114 and/or the third dielectric layer 116) may be made of a glass-epoxy material, e.g. FR4. It is easily understood that the above-mentioned material is only one example. Other materials may also be proper.

The present embodiment utilizes two electrodes and a dielectric layer located therebetween to make up the compensating capacitor of the clock generator without configuring real capacitors on the printed circuit board. As shown in FIG. 1, a pair of first electrodes 122/132 are located between the first dielectric layer 112 and the second dielectric layer 114 and separated from each other. A pair of second electrodes 124/134 are located between the second dielectric layer 114 and the third dielectric layer 116 and separated from each other. The projections of the second electrodes 124/134 on the first dielectric layer 112 overlap the first electrodes 122/132 respectively. Furthermore, the first electrodes 122/132 may be parallel with the second electrodes 124/134 respectively. Accordingly, the first electrode 122, the second electrode 124 and the second dielectric layer 114 located therebetween make up the compensating capacitor 120, and the first electrode 132, the second electrode 134 and the second dielectric layer 114 located therebetween make up the compensating capacitor 130.

Moreover, a pair of first conductive lines 150 electrically connect both terminals of the resonant circuit 140 to the second electrodes 124/134 respectively to output a timing signal. On the other hand, a pair of second conductive lines 160 electrically connect the first electrodes 122/132 to an outside potential, e.g. ground, such that the compensating capacitors 120/130 can be charged or discharged correctly.

The compensating capacitors 120/130 may have substantially the same capacitance to balance the charges of each terminal of the resonant circuit 140, such that the timing signal output by the resonant circuit 140 can be sustained and stable. Generically, the capacitance of a capacitor is determined by the overlap area and the distance between the electrodes of the capacitor and the dielectric constant of the dielectric layer of the capacitor. Therefore, the compensating capacitors 120/130 can have substantially the same capacitance when the compensating capacitors 120/130 have substantially the same above-mentioned parameters.

Specifically, the overlaps between the first electrodes 122/132 and the projections of the second electrodes 124/134 on the first dielectric layer 112 have the same area. That is, the overlap area between the first electrode 122 and the projection of the second electrode 124 on the first dielectric layer 112 is the same as the overlap area between the first electrode 132 and the projection of the second electrode 134 on the first dielectric layer 112.

Furthermore, each of the first electrodes 122/132 is located apart from one of the second electrodes 124/134 at a distance, and the distances are the same. That is, the distance between the first electrode 122 and the second electrode 124 is the same as the distance between the first electrode 132 and the second electrode 134.

Accordingly, the compensating capacitors 120/130 can have substantially the same capacitance because the dielectric layers for both the compensating capacitors 120/130 are made of the same material, i.e. the second dielectric layer 114. It is easily understood that the above mentioned size relationship is only one example. Other size relationships calculated by electronics may also be proper for making the compensating capacitors 120/130 have the same capacitance.

The following will disclose a prophetic example to illustrate that the compensating capacitors can provide enough capacitance for the resonant circuit. In this prophetic example, the structural connections and size described before are not repeated hereinafter, and only further information is supplied to actually perform the compensating capacitors. Specifically, the projections of the second electrodes 124/134 on the first dielectric layer 112 fully overlap the first electrodes 122/132 respectively, and all of the first electrodes 122/132 and the second electrodes 124/134 have substantially the same size. The lengths and the widths of the first electrodes 122/132 and the second electrodes 124/134 are 180 mils. Each of the first electrodes 122/132 is located apart from one of the second electrodes 124/134 at 5 mils. The second dielectric layer 114 is made of a FR4 glass-epoxy material, which has dielectric constant of 4.3. Accordingly, each of the compensating capacitors 120/130 will provide capacitance of 23.05358 pF.

The resonant circuit 140 shown in FIG. 1 is located above the compensating capacitors 120/130 to reduce wiring space on the printed circuit board 110 and enhance the efficiency of the compensating capacitors 120/130. Specifically, the resonant circuit 140 is disposed on a surface 118 of the printed circuit board 110, and the projections of the compensating capacitors 120/130 on the surface 118 of the printed circuit board 110 overlap the resonant circuit 140.

On the other hand, the compensating capacitors 120/130 are located below the resonant circuit 140. That is, the projection of the resonant circuit 140 on the first dielectric layer 112 overlaps the first electrodes 122/132, and/or the projection of the resonant circuit 140 on the second dielectric layer 114 overlaps the second electrodes 124/134.

In the present embodiment, the resonant circuit 140 may be a crystal oscillator, such as a quartz oscillator. The first electrodes 122/132 and the second electrodes 124/134 are made of copper, e.g. a piece of copper foil. More particularly, the first electrodes 122/132 and the second electrodes 124/134 may be the conductive layer of the multi-layer circuit board. Accordingly, manufacturers can actually perform the clock generator by designing the layout of the printed circuit board. It is easily understood that the above-mentioned material is only one example. Other materials may also be proper.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A clock generator, comprising:
a printed circuit board;
a resonant circuit disposed on the printed circuit board; and
a pair of compensating capacitors embedded in the printed circuit board and electrically connected to both terminals of the resonant circuit respectively, wherein the compensating capacitors have substantially the same capacitance.

2. (canceled)

3. The clock generator of claim 1, wherein the resonant circuit is disposed on a surface of the printed circuit board, and the projections of the compensating capacitors on the surface of the printed circuit board overlap the resonant circuit.

4. The clock generator of claim 1, wherein the printed circuit board is made of a glass-epoxy material.

5. The clock generator of claim 1, wherein the printed circuit board is a multi-layer circuit board.

6. The clock generator of claim 1, wherein the resonant circuit is a quartz oscillator.

7. A clock generator, comprising:
a printed circuit board comprising:
a first dielectric layer;
a second dielectric layer stacked on the first dielectric layer; and
a third dielectric layer stacked on the second dielectric layer;
a pair of first electrodes located between the first dielectric layer and the second dielectric layer and separated from each other;
a pair of second electrodes located between the second dielectric layer and the third dielectric layer and separated from each other, wherein the projections of the second electrodes on the first dielectric layer overlap the first electrodes respectively, and the first electrodes are parallel with the second electrodes respectively;
a resonant circuit disposed on the printed circuit board;
a pair of first conductive lines electrically connecting both terminals of the resonant circuit to the second electrodes respectively; and
a pair of second conductive lines electrically connecting the first electrodes to an outside potential.

8. (canceled)

9. The clock generator of claim 7, wherein the overlaps between the first electrodes and the projections of the second electrodes on the first dielectric layer have the same area.

10. The clock generator of claim 7, wherein each of the first electrodes is located apart from one of the second electrodes at a distance, and the distances are the same.

11. The clock generator of claim 7, wherein the projections of the second electrodes on the first dielectric layer fully overlap the first electrodes respectively.

12. The clock generator of claim 11, wherein the first electrodes have substantially the same size.

13. The clock generator of claim 11, wherein the second electrodes have substantially the same size.

14. The clock generator of claim 13, wherein each of the first electrodes is located apart from one of the second electrodes at a distance, and the distances are the same.

15. The clock generator of claim 7, wherein the projection of the resonant circuit on the first dielectric layer overlaps the first electrodes.

16. The clock generator of claim 7, wherein the projection of the resonant circuit on the second dielectric layer overlaps the second electrodes.

17. The clock generator of claim 7, wherein the printed circuit board is made of a glass-epoxy material.

18. The clock generator of claim 7, wherein the first dielectric layer, the second dielectric layer and the third dielectric layer are made of a glass-epoxy material.

19. The clock generator of claim 7, wherein the first electrodes and the second electrodes are made of copper.

20. The clock generator of claim 7, wherein the resonant circuit is a quartz oscillator.
